(19) United States
(12) Patent Application Publication
(10) Pub. No.: US 2017/0136729 A1
(43) Pub. Date: May 18, 2017

(54) METHOD OF PRODUCING COMPOSITE MATERIAL OF ALUMINUM AND CARBON FIBERS

(71) Applicant: SHOWA DENKO K.K., Tokyo (JP)

(72) Inventor: Tatsuhiro MIZO, Tochigi (JP)

(73) Assignee: SHOWA DENKO K.K., Tokyo (JP)

(21) Appl. No.: 15/312,853

(22) PCT Filed: Feb. 6, 2015
(86) PCT No.: PCT/JP2015/053411

§ 371 Date: Nov. 21, 2016

(30) Foreign Application Priority Data
May 21, 2014 (JP) 2014-105297

(51) Int. Cl. B32B 5/02; B65B 63/04; B65B 7/16; B32B 15/04; B32B 15/14

(52) U.S. Cl. CPC B32B 5/02; B32B 15/04; B32B 15/14; B65B 7/16; B65B 63/04

(57) ABSTRACT

A method of producing a composite material of aluminum and a carbon material includes applying a coating liquid containing carbon fibers, a binder, and a solvent for the binder in a mixed state on an aluminum foil to form a coating layer on the aluminum foil, removing the solvent contained in the coating layer to obtain a coated foil in which a carbon fiber layer is formed on the aluminum foil, a roll formation step of winding the coated foil in a roll shape to obtain a roll, removing the binder contained in the carbon fiber layer of the roll, and extruding the roll after the binder removal step. In the coating step, the coating liquid is applied on the aluminum foil so that a coating amount of the carbon fibers contained in the coating layer becomes equal to or less than 40 g/m².

### FIELD OF THE INVENTION

The present invention relates to a method of producing a composite material of aluminum and carbon fibers, and also to a composite material of aluminum and carbon fibers.

In this specification and claims, it should be noted that the wording of “aluminum” is used to include the meaning of both pure aluminum and aluminum alloys unless otherwise specifically defined.

### BACKGROUND ART

As a material in which the heat dissipation of aluminum is improved and the coefficient of thermal expansion is controlled, a composite material of aluminum and carbon has been studied.

As a method of producing the composite material, a method in which carbon powder is put in a molten aluminum and stirred and mixed (molten metal stirring method), a method in which molten aluminum is pressed into a carbon molding body having gaps (molten metal forging method), a method in which aluminum powder and carbon powder are blended and fired by heating under pressure (powder metallurgy method), a method in which aluminum powder and carbon powder are blended and extruded (powder extrusion method), etc., are known.

In these methods, however, since molten aluminum or aluminum powder is used, the production operation is complicated, and the production facility becomes large.

Japanese unexamined patent application publication No S62-66929 (Patent Document 1) describes a method in which SiC whisker as a reinforcing material is sprayed on an aluminum foil as a metal foil, then the aluminum foil is wound, the wound aluminum foil is extruded or rolled to produce an aluminum-based composite material as a composite material of aluminum and carbon.

### PRIOR ART DOCUMENT

### Patent Document

[Patent Document] Japanese unexamined patent application publication No S62-66929

### SUMMARY OF THE INVENTION

### Problems to be Solved by the Invention

However, in the production method described in the aforementioned publication, since the sprayed layer of the SiC whisker formed on the aluminum foil was too thick, the aluminum could not be sufficiently permeated in the sprayed layer, causing gaps in the sprayed layer, and the aluminum foils arranged on both sides of the sprayed layer could not be firmly joined. For the reasons, the strength of the composite material was low.

The present invention was made in view of the aforementioned technical background, and the purpose of the invention is to provide a method of producing a composite material of aluminum and carbon fibers having a high strength, and a composite material of aluminum and carbon fibers. The other objects and advantages of the present invention will be apparent from the following preferable embodiments.

### Means for Solving the Problems

The present invention provides the following means.

[1] A method of producing a composite material of aluminum and carbon fibers, includes:

a coating step of applying a coating liquid containing carbon fibers, a binder, and a solvent for the binder in a mixed state on an aluminum foil to form a coating layer on the aluminum foil;

a solvent removal step of removing the solvent contained in the coating layer to obtain a coated foil in which a carbon fiber layer is formed on the aluminum foil;

a roll formation step of winding the coated foil in a roll shape to obtain a roll;

a binder removal step of removing the binder contained in the carbon fiber layer of the roll; and

an extrusion step of extruding the roll after the binder removal step,

wherein in the coating step, the coating liquid is applied on the aluminum foil so that a coating amount of the carbon fibers contained in the coating layer becomes equal to or less than 40 g/m².

[2] The method of producing a composite material of aluminum and carbon fibers as recited in the aforementioned item [1], wherein a length of the carbon fibers contained in the coating liquid is equal to or less than 1 mm.

[3] The method of producing a composite material of aluminum and carbon fibers as recited in the aforementioned item [1] or [2], wherein in the coating step, the coating liquid is applied on the aluminum foil so that a volume of the aluminum foil exceeds 50% with respect to a total volume of a volume of the aluminum foil and a volume of the carbon fibers contained in the coating layer.

[4] The method of producing a composite material of aluminum and carbon fibers as recited in any one of the aforementioned items [1] to [3], wherein the coating liquid contains the carbon fibers and the binder so that a mass of the binder becomes 0.5% to 25% with respect to a mass of the carbon fibers.

[5] The method of producing a composite material of aluminum and carbon fibers as recited in any one of the aforementioned items [1] to [4], further including a covering step of covering an outer peripheral surface of the roll by an aluminum packaging material between the roll formation step and the binder removal step,

wherein in the binder removal step, the binder contained in the carbon fiber layer of the roll is removed after the covering step.

[6] The method of producing a composite material of aluminum and carbon fibers as recited in the aforementioned item [5], wherein in the covering step, the outer peripheral surface of the roll is covered by the packaging material by inserting the roll in an aluminum sheathing pipe as the packaging material.

[7] The method of producing a composite material of aluminum and carbon fibers as recited in the aforementioned item [5] or [6], further including a closing step of closing at least one of both end openings of the packaging material between the covering step and the binder removal step or between the binder removal step and the extrusion step.

[8] The method of producing a composite material of aluminum and carbon fibers as recited in the aforementioned item [7], wherein in the extrusion step, the roll is extruded in a state in which a closed end of the packaging material is arranged at a front of the extrusion direction.

[9] The method of producing a composite material of aluminum and carbon fibers as recited in the aforementioned item [7] or [8], wherein at least one of both end openings of the packaging material is closed by an aluminum lid.

[10] The method of producing a composite material of aluminum and carbon fibers as recited in the aforementioned item [5] or [6], further including a closing step of closing only one end opening of the packaging material by an aluminum lid between the covering step and the binder removal step, wherein in the extrusion step, the roll is extruded in a state in which a closed end of the packaging material is arranged at a front of the extrusion direction.

[11] The method of producing a composite material of aluminum and carbon fibers as recited in any one of the aforementioned items [5] to [10], wherein in the binder removal step, the roll is heated in the atmosphere at a temperature of 350 to 600° C. for one hour or more to remove the binder.

[12] A composite material of aluminum and carbon fibers obtained by the method of producing a composite material of aluminum and carbon fibers as recited in any one of the aforementioned items [1] to [11].

### Effects of the Invention

The present invention exerts the following effects.

In the aforementioned item [1], since applying a coating liquid on an aluminum foil, winding a foil into a roll shape, and extrusion are well-known techniques, which are method applicable to mass-production at a low cost, a composite material of aluminum and carbon fibers can be easily mass-produced.

Further, by applying the coating liquid on the aluminum foil so that the coating amount of the carbon fibers contained in the coating liquid becomes equal to or less than 40 g/m², at the time of the extrusion step, the aluminum of the aluminum foil sufficiently permeates in the carbon fiber layer by the extrusion pressure, and the aluminum foils arranged on both sides of the carbon fiber layers are sufficiently secured. Aa a result, a composite material of aluminum and carbon fibers having a high strength can be obtained.

Further, in the binder removal step, by removing the binder, the deterioration of the thermal conductivity of the composite material due to the residue of the binder can be suppressed.

Further, the composite material can be considered as an aluminum material reinforced by carbon fibers, and has a high Young's modules. Therefore, the composite material can be preferably used as a material of a member requiring a hardness such as, e.g., a bending strength.

In the aforementioned item [2], since the length of the carbon fibers contained in the coating liquid is equal to or less than 1 mm, the thickness of the coating layer and the content of the carbon fibers can be assuredly equalized.

In the aforementioned item [3], in the extrusion step, it is possible to assuredly permeate the aluminum of the aluminum foil in the carbon fiber layer. With this, the strength of the composite material can be assuredly enhanced.

In the aforementioned item [4], since the mass of the binder is 0.5% or more with respect to the mass of the carbon fibers, it becomes possible to assuredly make the carbon fiber 2 adhere to the aluminum foil in the coating step.

Further, since the mass of the binder is equal to or less than 25% with respect to the mass of the carbon fiber, it is possible to assuredly prevent remaining of the binder due to the excessive amount of the binder in the binder removal step. With this, the deterioration of thermal conductivity of the composite material by the residue of the binder can be further assuredly suppressed.

In the aforementioned item [5], by covering the outer peripheral surface of the roll by the packaging material, in the binder removal step and the extrusion step, dropping of the carbon fibers of the carbon fiber layer from the roll (in detail, the aluminum foil of the roll) can be suppressed.

Furthermore, at the time of carrying the roll or in the extrusion step, the outer peripheral surface of the roll can be protected by the packaging material so that the outer peripheral surface of the roll is not broken.

Further, when the roll is extruded, an aluminum layer is formed on the outermost layer of the obtained composite material, so the carbon fibers will not be exposed to the outermost peripheral surface. With this, it becomes possible to suppress a contact object which comes into contact with the outermost peripheral surface of the composite material from being contaminated by the carbon fibers, and also possible to suppress dropping of the carbon fibers.

In the aforementioned item [6], by inserting the roll in the sheathing pipe as a packaging material, the operation of covering the outer peripheral surface of the roll by the packaging material can be easily performed, and the effects of the aforementioned item [5] can be assuredly exerted.

In the aforementioned item [7], by closing at least one of both end openings of the packaging material, at the time of, e.g., carrying the roll, the winding deviation of the roll can be suppressed, and dropping of the roll from the inside of the packaging material can also be suppressed.

In the aforementioned item [8], by extruding the roll with the closed end of the sheathing pipe arranged at a front of the extrusion direction, winding deviation of the roll in the extrusion direction can be suppressed in the extrusion step. With this, the content rate of the carbon fibers to the aluminum can be equalized in the extrusion direction.

In the aforementioned item [9], the effects of the aforementioned item [7] or [8] can be assuredly exerted.

In the aforementioned item [10], in order to obtain any one of effects of the aforementioned items [7] to [9], it is sufficient to close only one end opening of the packaging material by the lid.

Further, since only the one end opening of the packaging material is closed, sublimation gases and decomposition gases of the binder generated in the packaging material in the binder removal step can be leaked from the other end opening of the packaging material. Therefore, the binder can be assuredly removed. With this, the deterioration of thermal conductivity of the composite material by the residue of the binder can be further assuredly suppressed.

Further, since the one end opening of the packaging material is closed by the lid, at the time of carrying the roll or in the extrusion step, the winding deviation of the roll can be assuredly suppressed, and dropping of the roll from the inside of the packaging material can be assuredly suppressed.

In the aforementioned item [11], by heating the roll in the atmosphere at a temperature of 350 to 600° C. for one hour or more, oxidative consumption of the carbon fibers can be assuredly suppressed. Needless to say, since the heating for removing the binder is performed in the atmosphere, the removal of the binder can be easily performed.

In the aforementioned item [12], a composite material of aluminum and carbon fibers having a high strength can be obtained.

### BRIEF DESCRIPTION OF THE DRAWINGS

FIG. 1 is a flowchart of production steps of a composite material of aluminum and carbon fibers according to a first embodiment of the present invention.

FIG. 2 is a schematic view illustrating from a coating step to a solvent removal step.

FIG. 3 is a schematic view illustrating a roll formation step.

FIG. 4 is a schematic view illustrating a covering step.

FIG. 5 is a schematic view illustrating a closing step.

FIG. 6 is a schematic view illustrating a binder removal step.

FIG. 7A is a schematic view illustrating a state in which a roll is loaded in a container of an extrusion device in an extrusion step.

FIG. 7B is a schematic view illustrating a state in which the roll is being extruded using the extrusion device.

FIG. 8 is a schematic enlarged cross-sectional view showing a state of the aluminum foils and the carbon fiber layer in the roll before the extrusion and a state thereof after the extrusion.

FIG. 9 is a view corresponding to FIG. 8 in a case in which a coating amount of carbon fibers is excessive.

FIG. 10 is a schematic view illustrating a state in which the composite material is being cut.

FIG. 11 is a flowchart of production steps of a composite material of aluminum and carbon fibers according to a second embodiment of the present invention.

### EMBODIMENTS FOR CARRYING OUT THE INVENTION

Next, some embodiments of the present invention will be described below with reference to drawings.

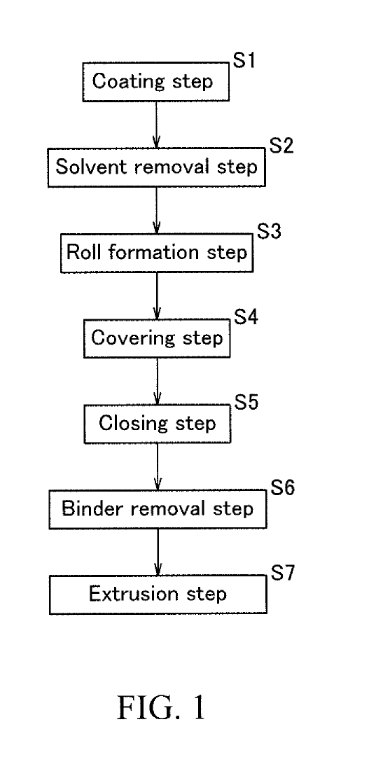

A method of producing a composite material of aluminum and carbon fibers according to a first embodiment of the present invention includes, as shown in FIG. 1, a coating step S1, a solvent removal step S2, a roll formation step S3, a covering step S4, a closing step S5, a binder removal step S6, and an extrusion step S7, and these steps are performed in this order.

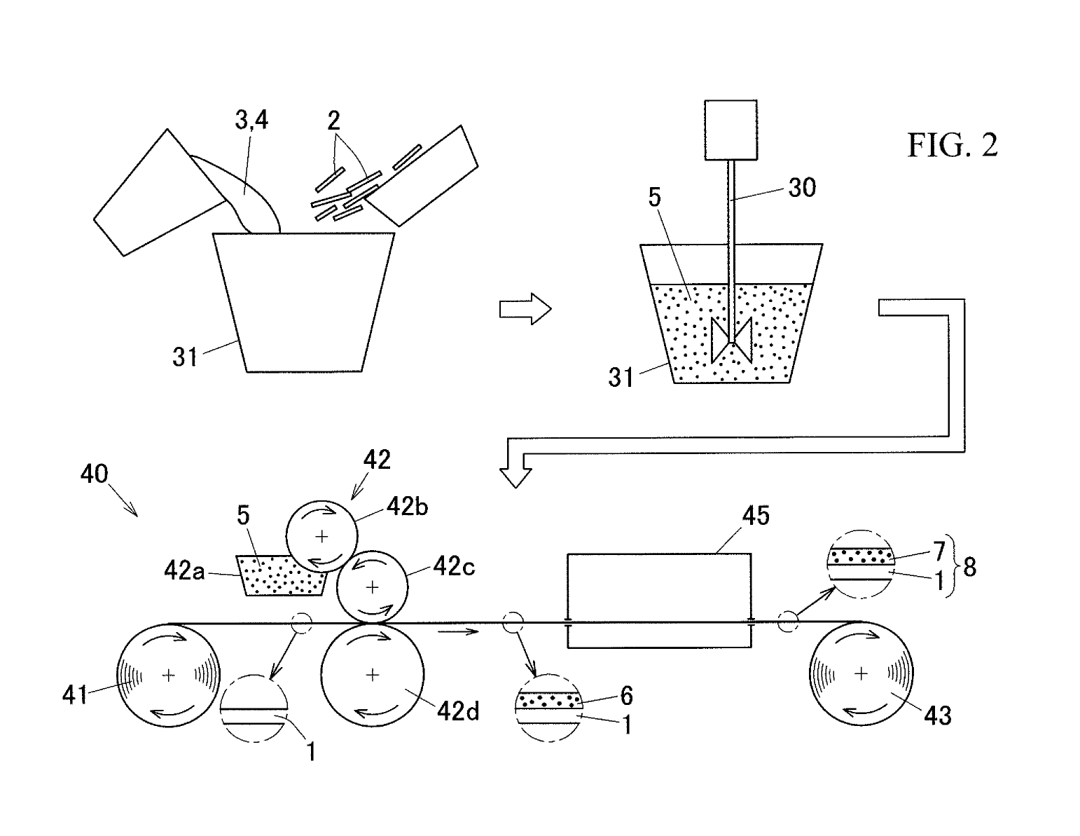

The coating step S1 is, as shown in FIG. 2, a step of forming a coating layer 6 on an aluminum foil 1 by applying a coating liquid 5 containing carbon fibers 2, a binder 3, and a solvent 4 for the binder 3 in a mixed state on the aluminum foil 1.

The solvent removal step S2 is a step of obtaining a coated foil 8 in which a carbon fiber layer 7 is formed on the aluminum foil 1 by removing the solvent 4 contained in the coating layer 6.

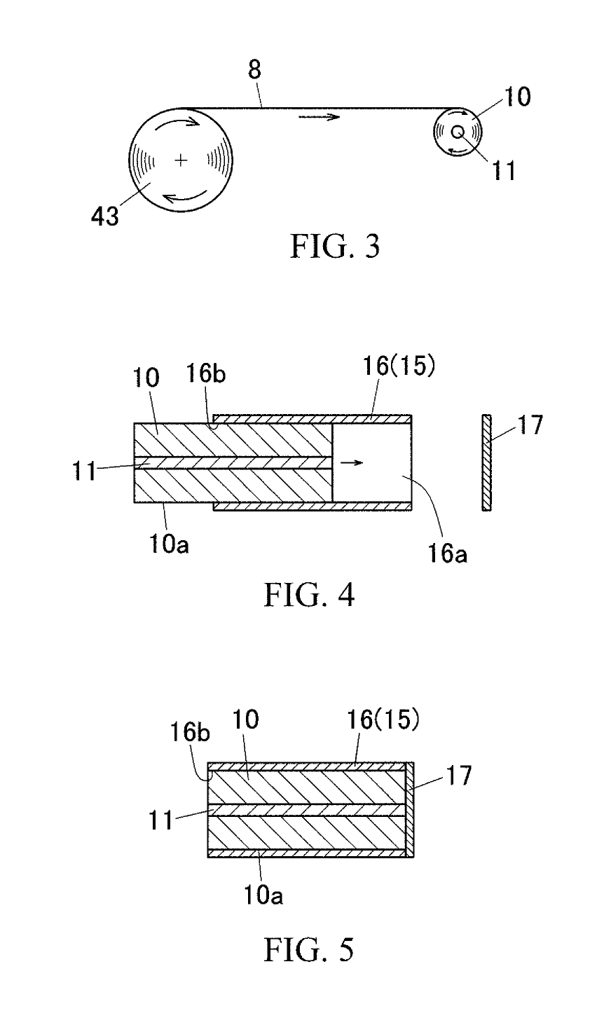

The roll formation step S3 is, as shown in FIG. 3, a step of obtaining a roll 10 by winding the coated foil 8 in a roll shape.

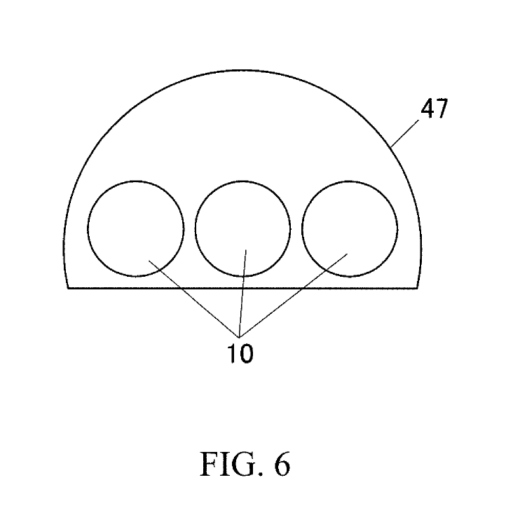

The covering step S4 is, as shown in FIGS. 4 and 5, a step of covering an outer peripheral surface 10a of the roll 10 with an aluminum packaging material 15.

The closing step S5 is, as shown in FIG. 5, a step of closing at least one of both longitudinal end openings of the packaging material 15.

The binder removal step S6 is, as shown in FIG. 6, a step of removing the binder 3 contained in the carbon fiber layer 7 (see FIG. 2) of the roll 10.

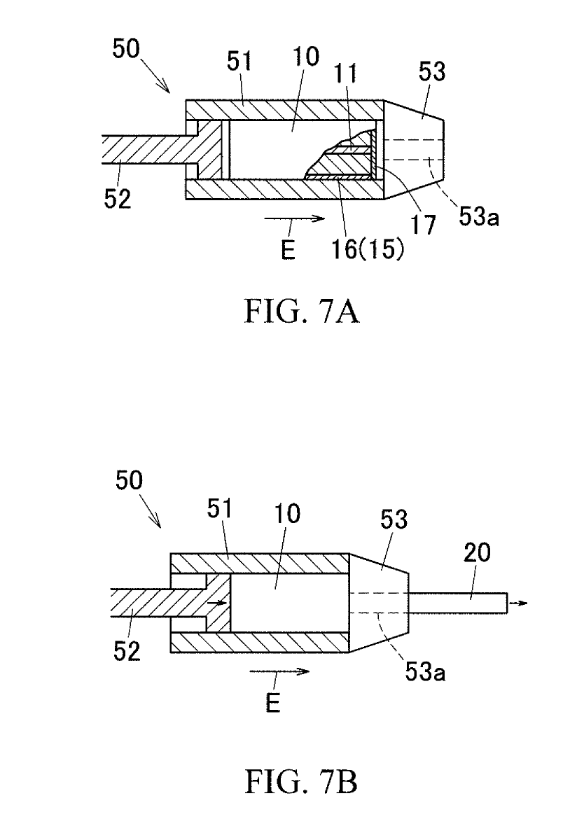

The extrusion step S7 is, as shown in FIGS. 7A and 7B, a step of obtaining the composite material 20 by extruding the roll 10.

Further, in the coating step S1, it is required that the coating liquid 5 is applied on the aluminum foil 1 so that the coating mount of the carbon fibers 2 contained in the coating layer 6 becomes 40 g/m² or less.

Here, in detail, the coating amount of the carbon fibers 2 contained in the coating layer 6 denotes a coating amount when components other than the carbon fibers 2 among all components (carbon fibers 2, binder 3, solvent 4, etc.) constituting the coating layer 6 are excluded. That is, the coating amount means the coating amount of only the carbon fibers 2 contained in the coating layer 6.

The composite material 20 obtained in the first embodiment contains carbon fibers 2 and therefore is high in thermal conductivity. Therefore, the heat dissipation is good, and further the linear expansion coefficient is about in the middle between metal and ceramic. For these reasons, the composite material 20 can be preferably used for a material of a thermal stress buffer layer in a power module.

Further, the composite material 20 can be considered as an aluminum material reinforced by the carbon fibers 2, and has a high Young's modulus. Therefore, the composite material 20 can be preferably used as a material for a member requiring a hardness such as, e.g., a bending strength.

Next, each step will be described in detail.

### <Coating Step S1>

A coating liquid 5 used in the coating step S1 is obtained, for example, as follows. That is, as shown in FIG. 2, carbon fibers 2, a binder 3, and a solvent 4 are put in a blending vessel 31, and these are stirred and mixed with a stirrer equipped with stirring blades (e.g., mixer or blender) 30. With this, a coating liquid 5 containing the carbon fibers 2, the binder 3, and the solvent 4 in a mixed state is obtained. At this time, dispersant, antifoamer, surface conditioner, viscosity modifier, etc., may be put in the blending vessel 31 and stirred and mixed.

The coating liquid 5 is applied on approximately the entire surface on one surface of the aluminum foil 1 in a layer manner by a coating device 40. In this first embodiment, the aluminum foil 1 is long, and specifically, the one surface of the aluminum foil 1 on which the coating liquid 5 is applied is an upper surface.

As the coating device 40, any device that is well known to apply the coating liquid 5 on the aluminum foil 1 may be used. Specifically, a roll coater, a knife coater, a die coater, a gravure coater, etc., may be used.

In the coating device 40 shown in FIG. 2, the long aluminum foil 1 unwound from the unwinding roller 41 passes a coating roller unit 42 and a drying furnace 45 as a drying device sequentially and is wound on a winding roller 43. The application of the coating liquid 5 on the aluminum foil 1 is performed at the coating roller unit 42. That is, in the aluminum foil 1 unwound from the unwinding roller 41, the coating liquid 5 is applied approximately on the entirety of the one surface (the upper surface) of the aluminum foil 1 when passing the coating roller unit 42, so that the coating layer 6 is formed approximately on the entire surface of the aluminum foil 1.

The coating roller unit 42 includes a coating liquid pan 42a, a pickup roller 42b, an applicator roller 42c, a backup roller 42d, etc.

The drying furnace is configured to remove the solvent 4 contained in the coating layer 6 by drying the coating layer 6 formed on the aluminum foil 1.

The carbon fibers 2 contained in the coating liquid 5 may be any fiber as long as it is fibrous. Specifically, for example, a mixture of two or more carbon fibers selected from the group consisting of a PAN-based carbon fiber, a pitch-based carbon fiber, and a carbon nanotube (e.g. a vapor-grown carbon nanofiber, a single wall carbon nanotube, a multi-walled carbon nanotube) may be used.

The length of the carbon fibers 2 is not limited, but is preferably as short as possible, more preferably 1 mm or less. The reason is as follows.

That is, when the carbon fiber 2 is long, in the case of using a coating device 40 like a die coater in which the coating liquid 5 is configured to pass a narrow passage, the passage may be clogged, which in turn may result in an uneven thickness of the coating layer 6 and an uneven content of the carbon fiber. On the other hand, when the length of the carbon fiber 2 is 1 mm or less, the aforementioned drawbacks can be assuredly prevented from occurring, which in turn can assuredly attain an even thickness of the coating layer 6 and an even content of the carbon fibers. The lower limit of the length of the carbon fiber 2 is not limited, and normally five times the fiber diameter of the carbon fiber 2.

The fiber diameter of the carbon fiber 2 is not limited. For example, the average fiber diameter of the carbon fiber 2 is 0.1 nm to 20 μm. Especially, for a PAN-based carbon fiber and a pitch-based carbon fiber, it is preferable that the fiber is a chopped fiber or a milled fiber and the average fiber diameter is 5 to 15 μm. For a vapor-grown carbon nanofiber, it is desirable that the average fiber diameter is 0.1 nm to 20 μm.

The binder 3 imparts adhesion to the carbon fibers 2 with respect to the aluminum foil 1 to thereby prevent dropping of the carbon fibers 2 contained in the coating layer 6 from the aluminum foil 1. The binder 3 is normally made of resin.

Further, when heated, the binder 3 readily becomes a sintering residue of an organic substance or an amorphous carbide, which becomes a factor of lowering the thermal conductivity of the composite material 20 as a residue of the binder 3. Therefore, for the binder 3, it is preferable to use a binder that disappears by sublimation or decomposition without being carbonized at a temperature of 300 to 600° C. in a non-oxidizing atmosphere. For such a binder 3, acrylic resin, polyethylene glycol resin, butyl rubber resin, phenolic resin, and cellulose-based resin are preferably used.

For the solvent 4, the type is not limited as long as it dissolves the binder 3. As the solvent 4, water, alcohol solvent (e.g. methanol, isopropyl alcohol), hydrocarbon-based solvent, etc., are preferably used.

Further, in the coating step S1, as described above, it is required that the coating liquid is applied on the aluminum foil so that the coating mount of the carbon fibers 2 contained in the coating layer 6 becomes 40 g/m² or less. The reasons will be described later.

It is preferable that the coating liquid 5 contains the carbon fibers 2 and the binder 3 so that the mass of the binder 3 is 0.5% to 25% with respect to the mass of the carbon fibers 2. When the mass of the binder 3 is 0.5% or more with respect to the mass of the carbon fibers 2, it becomes possible to assuredly make the carbon fiber 2 adhere to the aluminum foil 1 in the coating step S1. When the mass of the binder 3 is 25% or less with respect to the mass of the carbon fiber 2, it becomes possible to assuredly prevent remaining of the binder 3 in the carbon fiber layer 7 due to the excessive amount of the binder 3 in the binder removal step S6. This assuredly can control the deterioration of thermal conductivity of the composite material 20 due to the residue of the binder 3.

Further, in the coating step S1, it is preferable that the coating liquid 5 is applied on the aluminum foil 1 so that the volume V1 of the aluminum foil 1 exceeds 50% with respect to the total volume V1+V2 of the volume V1 of the aluminum foil 1 and the volume V2 of the carbon fiber 2 contained in the coating layer 6 as a ratio of the volume of the aluminum and the volume of the carbon fiber 2. In other words, it is preferable that the coating liquid 5 is applied on the aluminum foil 1 so as to satisfy the formula of V1/(V1+V2)>0.5. With this, in the extrusion step S7, it becomes possible that the aluminum of the aluminum foil 1 can be assuredly permeated into the carbon fiber layer 7.

Here, in cases where the composite material 20 is used as, for example, a material of a thermal stress buffer layer in a power module, it is preferable to set the ratio of the volume of the aluminum and the volume of the carbon fiber 2 so that the linear expansion coefficient of the composite material 20 becomes an intermediate value between a linear expansion coefficient of a ceramic layer (electrical insulation layer) of a power module and a linear expansion coefficient of a wiring layer of the power module, or an intermediate value between a linear expansion coefficient of a ceramic layer and a linear expansion coefficient of a cooling member. Especially, in order to bring the linear expansion coefficient of the composite material 20 to an intermediate value between a linear expansion coefficient (e.g., about 3 to 5×10⁻⁶/K) of ceramic (aluminum nitride, alumina, silicon carbide, etc.) commonly used as a material of an electrical insulation layer and a linear expansion coefficient (about 23×10⁻⁶/K) of aluminum commonly used as a material of a cooling member (or a wiring layer), it is preferable that the volume V1 of the aluminum foil 1 is set to be not smaller than 50% and not larger than 90% with respect to the aforementioned total volume of V1+V2.

In order to differentiate the thermal conductivity of the composite material 20 from the thermal conductivity (225 W/(m·K) of a normal aluminum material which does not contain the carbon fibers 2, it is especially preferable that the volume V1 of the aluminum foil 1 is set to be equal or less than 90% with respect to the aforementioned total volume of V1+V2.

The aluminum foil 1 is not limited in material as long as it can withstand coating, and an aluminum foil made of aluminum of various materials, such as A1000 series aluminum, A3000 series aluminum, A6000 series aluminum, etc., may be used. Further, since the thermal conductivity of the aluminum foil 1 differs depending on the material of the aluminum foil 1, it is possible to select the material of the aluminum foil 1 so that the thermal conductivity of the composite material 20 becomes a desired set value.

Further, the thickness of the aluminum foil 1 is not limited, and can be selected so that the physical properties (thermal conductivity, linear expansion coefficient, etc.) of the composite material 20 become a desired set value.

The thinnest thickness of a commercially available aluminum foil 1 is 6 μm, and therefore it is preferable that the lower limit of the thickness of the aluminum foil 1 is 6 μm from the viewpoint that the aluminum foil 1 can be easily obtained. On the other hand, as to the upper limit of the thickness of the aluminum foil 1, since there is a coating amount upper limit (40 g/m²) of the carbon fibers 2 contained in the coating layer 6, based on the ratio of the volume of the aluminum of the aluminum foil 1 and the volume of the carbon fibers 2, the coating amount of the carbon fibers 2 on the aluminum foil 1, etc., the upper limit of the thickness of the aluminum foil 1 can be calculated. For example, the upper limit of the thickness of the aluminum foil 1 is about 100 μm, normally 15 to 50 μm.

### <Solvent Removal Step S2>

The solvent removal step S2 is performed in the drying furnace 45 of the coating device 40. In detail, when the aluminum foil 1 in which the coating layer 6 was formed by the coating roller unit 42 passes through the drying furnace 45, the solvent 4 contained in the coating layer 6 is removed by being evaporated in the drying furnace 45. As a result, a coated foil 8 in which the carbon fiber layer 7 from which the solvent 4 was removed from the coating layer 6 was formed on the aluminum foil 1 is obtained. The coated foil 8 is wound on the winding roller 43.

The removal conditions of the solvent 4 by the drying furnace 45 are not limited as long as they are conditions capable of evaporating and removing the solvent 4 contained in the coating layer 6 from the coating layer 6. For example, drying conditions of a drying temperature of 60 to 150° C. and a drying time of 5 to 60 min may be applicable as the removal conditions of the solvent 4.

In this first embodiment, since large voids may sometimes be generated in the carbon fiber layer 7 after the removal of the solvent 4, it is possible to adjust the bulk density of the carbon fiber layer 7 by pressing the carbon fiber layer 7 with a pressing roller (not illustrated).

### <Roll Formation Step S3>

In the roll formation step S3, as shown in FIG. 3, the roll 10 is obtained by winding the coated foil 8 wound on the winding roller 43 on an aluminum winding core 11 in a roll shape.

The winding operation of the coated foil 8 is terminated when the roll 10 has reached a desired diameter. That is, the number of windings of the coated foil 8 is set depending on the desired diameter of the roll 10. The desired diameter of the roll 10 is not limited, and is set, for example, corresponding to the bullet diameter (normally, 70 to 510 mm) capable of being loaded in a container 51 of an extrusion device 50 for use in the extrusion step S7 in a state in which the outer peripheral surface 10a of the roll 10 is covered with the packaging material 15.

In this roll formation step S3, since the coated foil 8 is wound on the winding core 11, the coated foil 8 can be assuredly and easily wound into a roll shape.

The material of the winding core 11 may be the same material as the aluminum foil 1, and may be a material different from the material of the aluminum foil 1. The diameter of the winding core 11 is not limited, but is preferably as small as possible, for example, 5 to 8 mm.

### <Covering Step S4>

In the covering step S4, as shown in FIGS. 4 and 5, the outer peripheral surface 10a of the roll 10 is covered with the aluminum packaging material 15.

In this first embodiment, the packaging material 15 has a pipe shape. That is, as the packaging material 15, an aluminum sheathing pipe 16 is used. Both longitudinal ends of the sheathing pipe 16 are opened, respectively. The roll 10 is inserted into the sheathing pipe 16 from the end opening 16b of the sheathing pipe 16 in a manner that the axial direction of the roll 10 is parallel to the longitudinal direction of the sheathing pipe 16, so that approximately the entire surface of the outer peripheral surface 10a of the roll 10 is covered with the sheathing pipe 16 (packaging material 15). In this covered state, it is preferable that approximately the entirety of the outer peripheral surface 10a of the roll 10 is in close contact with the inner peripheral surface of the sheathing pipe 16.

In this first embodiment, as the packaging material 15, a sheathing pipe 16 is used. However, in the present invention, other than the above, for example, although not illustrated, a non-coated aluminum foil may be used as the packaging material 15. In this case, the packaging material is formed by winding an aluminum foil having no coating layer 6 or carbon fiber layer 7 on the outer peripheral surface 10a of the roll 10 by one or plural times.

In this covering step S4, since the outer peripheral surface 10a of the roll 10 is covered with the packaging material 15, in the binder removal step S6 and the extrusion step S7, dropping of the carbon fibers 2 of the carbon fiber layer 7 from the roll 10 (in detail, the aluminum foil 1 of the roll 10) can be suppressed.

Furthermore, at the time of carrying the roll 10 or in the extrusion step S7, the outer peripheral surface 10a of the roll 10 can be protected by the packaging material 15 so that the outer peripheral surface 10a of the roll 10 is not broken. Further, as will be described later, when the roll 10 is extruded, an aluminum layer is formed on the outermost layer of the obtained composite material 20, so the carbon fibers 2 will not be exposed to the outermost peripheral surface. With this, it becomes possible to suppress a contact object which comes into contact with the outermost peripheral surface of the composite material 20 from being contaminated by the carbon fibers 2, and also possible to suppress dropping of the carbon fibers 2.

Especially, in this first embodiment, since the sheathing pipe 16 is used as the packaging material 15, the operation of covering the outer peripheral surface 10a of the roll 10 with the packaging material 15 can be performed by an insertion into the sheathing pipe 16 of the roll 10. With this, without using a special jig, unintended unwinding of the roll 10 can be prevented, which in turn can easily perform the covering operation. Further, the aforementioned functions and effects by the packaging material 15 can be assuredly exerted.

The thickness of the sheathing pipe 16 (packaging material 15) is not limited as long as it is a thickness having a strength capable of exerting the aforementioned functions and effects by the sheathing pipe 16 (packaging material 15). However, it is preferable that the thickness is as thinner as possible, and it is especially preferable to be set to 2 to 10 mm.

Further, in this first embodiment, by shrink-fitting the roll 10 in the sheathing pipe 16, the outer peripheral surface 10a of the roll 10 may be covered with the sheathing pipe 16. By doing so, the roll 10 is fixed in the sheathing pipe 16, which in turn can assuredly exert the aforementioned functions and effects by the packaging material 15.

### <Closing Step S5>

In the closing step S5, as shown in FIG. 5, at least one of both longitudinal end openings 16a and 16b of the sheathing pipe 16 (packaging material 15) is closed. In this first embodiment, only one end opening 16a of the sheathing pipe 16 is closed, and the other end opening 16b is not closed. Further, as a member of closing the one end opening 16a of the sheathing pipe 16, a disk-shaped lid 17 is used.

In detail, the lid 17 is arranged on one end face of the sheathing pipe 16 so as to close the opening 16a. With this state, the lid 17 is fixed to the one end of the sheathing pipe 16 at the overlapped portion thereof by welding (including a friction agitation welding), swaging, etc., so that the one end opening 16a of the sheathing pipe 16 is closed.

In this closing step S5, since at least one of both end openings 16a and 16b of the sheathing pipe 16 is closed, at the time of, e.g., carrying the roll 10, winding deviation of the roll 10 can be suppressed, and dropping of the roll 10 from the inside of the sheathing pipe 16 can also be suppressed.

Further, since at least one of both end openings 16a an 16b of the sheathing pipe 16 is closed, at the time of, e.g., carrying the roll 10, winding deviation of the roll 10 can be assuredly suppressed, and dropping of the roll 10 from the inside of the sheathing pipe 16 can also be assuredly suppressed at the time of carrying the roll 10.

### <Binder Removal Step S6>

In the binder removal step S6, as shown in FIG. 6, the binder 3 is removed by heating the roll 10 in the atmosphere or in a non-oxidizing atmosphere (e.g., vacuum, nitrogen gas, argon gas) using an industrial oven 47 that can heat the roll 10 as a heating furnace. It is preferable that the heating condition is heating of the roll 10 in the atmosphere (i.e., in the air at about one atmosphere pressure) at a temperature of 350 of 600° C. The preferable upper limit of the heating time is not limited, but normally 5 hours.

In general, when a complex containing carbon fibers is exposed in the atmosphere of high temperature for a long period of time, the carbon and oxygen in the atmosphere react to become carbon gas such as carbon dioxide, resulting in oxidative consumption of the carbon fibers.

On the other hand, in this first embodiment, since the outer peripheral surface 10a of the roll 10 is covered with the sheathing pipe (packaging material 15), oxygen existing on the outside of the sheathing pipe 16 is less likely to enter the inside of the sheathing pipe 16. For this reason, oxygen existing on the inside of the sheathing pipe 16 reacts with the carbon fibers 2 and the binder 3 contained in the roll 10 and disappears, and thereafter a state in which oxygen is less likely to enter the inside of the sheathing pipe 16 is held. Further, since the one end opening 16a of the sheathing pipe 16 is closed, the sealing degree of the sheathing pipe 16 is improved. As a result, even if the roll 10 is heated in the atmosphere at the temperature of 350 to 450° C. for one hour or more by the oven 47, the carbon fibers 2 contained in the roll 10 does not hardly cause oxidative consumption, so the binder 3 contained in the roll 10 is removed.

Further, since only the one end opening 16a of the sheathing pipe 16 is closed, sublimation gas and decomposition gas of the binder 3 generated in the sheathing pipe 16 exit from the other end opening 16b of the sheathing pipe 16. Therefore, the binder 3 can be assuredly removed. With this, the deterioration of thermal conductivity of the composite material 20 by the residue of the binder 3 can be further assuredly suppressed.

Further, the carbon fibers 2 becomes more likely to drop from the roll 10 by the removal of the binder 3 from the carbon fiber layer 7. However, in this embodiment, since the outer peripheral surface 10a of the roll 10 is covered with the sheathing pipe 16 (packaging material 15), dropping of the carbon fibers 2 can be prevented.

### <Extrusion Step S7>

In the extrusion step S7, the roll 10 is extruded in the following manner. That is, as shown in FIG. 7A, the roll 10 is loaded in the container 51 of the extrusion device 50 in a state in which the closed one end (i.e., the lid 17) of the sheathing pipe 16 (packaging material 15) is arranged at the front of the extrusion direction E. In this state, the axial direction of the roll 10 is in parallel to the extrusion direction E. In this state, as shown in FIG. 7B, the roll 10 is extruded by a stem 52 of the extrusion device 50 in the extrusion direction E. With this, the roll 10 is pressed into the inside of an extrusion shaping hole 53a of the extrusion die 53 to perform extrusion. As a result, a long bar-shaped composite material 20 as an extruded product can be obtained.

Although the extrusion condition is not limited and it is possible to set the condition variously, it is especially preferable that the container temperature is set to 450 to 600° C., the extrusion die temperature is set to 450 to 550° C., and the extrusion rate is set to 0.1 to 10,000 mm/min.

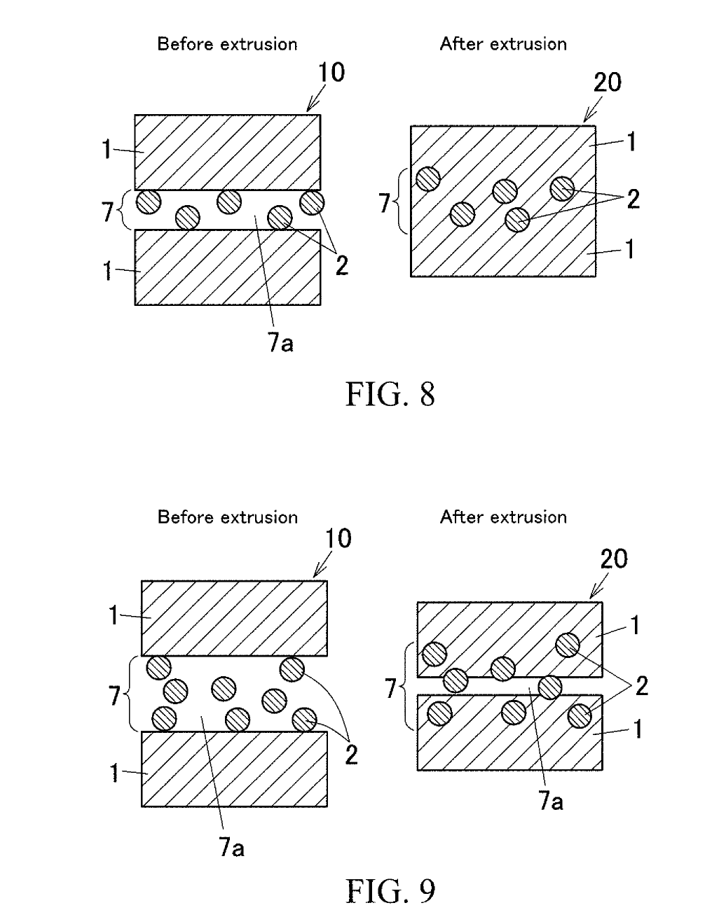

In this extrusion step S7, as shown in FIG. 8, in the roll 10 before the extrusion processing, the carbon fiber layer 7 and the aluminum foil 1 are arranged alternately in the radial direction of the roll 10 in a laminated manner. Thus, on both sides of the carbon fiber layer 7, the aluminum foils 1 and 1 are arranged. Further, in the carbon fiber layer 7, there exist gaps 7a caused by, e.g., the removal of the solvent 4 and the binder 3 in the carbon fiber layer 7.

Here, in the coating step S1, in cases where the coating liquid 5 was applied on the aluminum foil 1 so that the coating amount of the carbon fibers 2 contained in the coating layer 6 became 40 g/m² or less, when the roll 10 is extruded, as shown in the figure, the aluminum of each aluminum foil 1 sufficiently permeates approximately the entire gaps 7a in the carbon fiber layer 7 by the extrusion pressure and both the aluminum foils 1 and 1 are sufficiently secured. As a result, the strength (mechanical strength, etc.) of the composite material 20 increases.

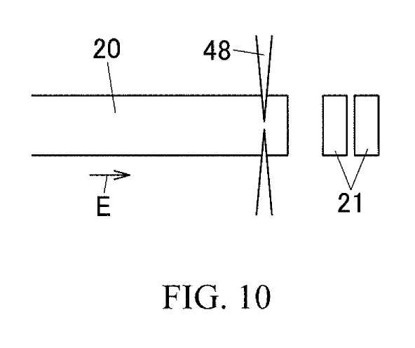

On the other hand, in cases where the coating liquid 5 was applied on the aluminum foil 1 so that the coating amount of the carbon fibers 2 contained in the coating layer 6 exceeded 40 g/m², as shown in FIG. 10, since the carbon fiber layer 7 is too thick, even if the roll 10 is extruded, the aluminum of each aluminum foil 1 does not sufficiently permeate in the gaps 7a in the carbon fiber layer 7 by the extrusion pressure, and both the aluminum foils 1 and 1 will not be sufficiently secured. As a result, the strength of the composite material 20 becomes week.

Therefore, in order to obtain a composite material 20 having a high strength, in the coating step S1, it is required that the coating liquid 5 is applied on the aluminum foil 1 so that the coating mount of the carbon fibers 2 contained in the coating layer 6 becomes 40 g/m² or less.

Further, in order to shorten the time required for the production of the composite material 20, it is especially preferable that the coating amount of the carbon fibers 2 is equal to or less than 30 g/m².

The lower limit of the coating amount of the carbon fibers 2 is not limited, and can be variously set depending on, e.g., the ratio of the volume of the aluminum of the aluminum foil 1 and the volume of the carbon fibers 2. For example, it can be set to 1.5 g/m².

In the extrusion step S7, as described above, since the outer peripheral surface 10a of the roll 10 is covered with the sheathing pipe 16 (packaging material 15), an aluminum layer is formed on the outermost layer of the obtained composite material 20, so the carbon fibers 2 will not be exposed to the outermost peripheral surface. With this, it becomes possible to suppress a contact object which comes into contact with the outermost peripheral surface of the composite material 20 from being contaminated by the carbon fibers 2, and also possible to suppress dropping of the carbon fibers 2.

Further, by extruding the roll 10 with the closed one end of the sheathing pipe 16 arranged at the front of the extrusion direction E, winding deviation of the roll 10 in the extrusion direction E can be suppressed in the extrusion step S7. With this, the content of the carbon fibers 2 with respect to the aluminum can be equalized in the extrusion direction E.

Further, since the one end opening 16a of the sheathing pipe 16 is closed by the lid 17, in the extrusion step S7, winding deviation of the roll 10 in the extrusion direction E can be assuredly suppressed. With this, the content of the carbon fibers 2 with respect to the aluminum can be further assuredly equalized in the extrusion direction E.

The thickness of the lid 17 is not limited as long as it is a thickness having a strength capable of exerting the aforementioned functions and effects by the lid 17. However, it is preferable that the thickness is equal to or thicker than the thickness of the sheathing pipe 16 (packaging material 15) from the viewpoint of dispersion of force.

The composite material 20 obtained in the extrusion step S7 is, as shown in FIG. 10, cut into a predetermined size or shape depending on the desired application by cutting blade 48, etc. Here, the carbon fibers 2 in the roll 10 is re-arranged approximately in parallel to the extrusion direction E by the extrusion, so the carbon fibers 2 in the composite material 20 are oriented in the extrusion direction E. For this reason, the properties of the composite material 20 such as, e.g., thermal conductivity, electrical characteristics, and strength, strongly depend on the direction. In other words, the properties of the composite material 20 such as, e.g., thermal conductivity, electrical characteristics, and strength, are anisotropic. Therefore, at the time of cutting the composite material 20, it is preferable to cut the composite material 20 in a cutting direction that the properties of the cut piece 21 match the properties of the desired application.

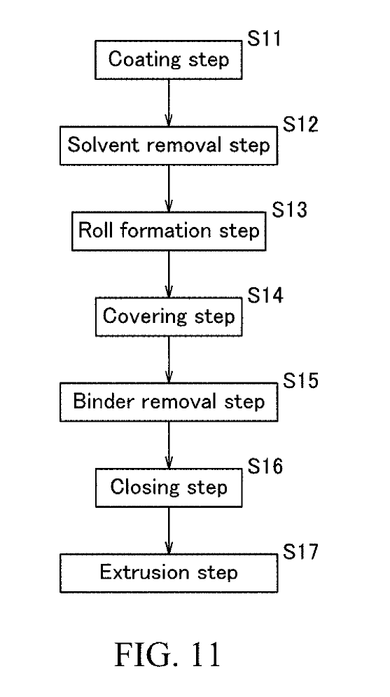

FIG. 11 is a flowchart of production steps of the composite material of the aluminum and the carbon fibers according to a second embodiment of the present invention.

The method of producing a composite material according to the second embodiment includes, as shown in FIG. 11, a coating step S11, a solvent removal step S12, a roll formation step S13, a covering step S14, a binder removal step S15, a closing step S16, and an extrusion step S17, and these steps are performed in this order. That is, the closing step S16 is performed between the binder removal step S15 and the extrusion step S17.

Each step in the production method according to the second embodiment is the same as in the aforementioned first embodiment.

Several embodiments of the present invention have been described above, but the present invention is not limited to the aforementioned embodiments. It is needless to say that various modifications can be made within a range not deviating from the gist of the present invention.

### EXAMPLES

Next, specific examples and comparative examples of the present invention will be described below. However, it should be noted that the present invention is not limited to the examples described below.

### Example 1

In Example 1, a composite material of aluminum and carbon fibers was produced by the following steps.

Carbon fibers having a length of 150 μm and an average fiber diameter of 10 μm (made by Nippon Graphite Fiber Co., Ltd.: XN-100), 3 mass % of an aqueous solution of polyethylene oxide having an average molecular weight of 700,000 (made by Meisei Chemical Industry Co., Ltd., Al Cox (registered trademark) E-45) as a binder, isopropyl alcohol as a solvent, dispersant, and surface conditioner were stirred and mixed. Thus, a coating liquid was obtained. The mass of the binder contained in the coating liquid was 3% in the solid content with respect to the mass of the carbon fibers contained in the coating liquid. The viscosity of the coating liquid was 1,000 mPa·s.

The coating liquid was applied on the entire surface of one surface of a long aluminum foil (material: 1N30) having a thickness of 20 μm and a width of 280 mm by a knife coater to form a coating layer on the aluminum foil, and the coating layer was dried in a drying furnace to remove the solvent contained in the coating layer. With this, a coated foil in which a carbon fiber layer was formed on the aluminum foil was obtained. The coating amount of the carbon fibers contained in the coating layer was 30 g/m².

Next, the coated foil was wound on an aluminum winding core (material: 1050) having a diameter of 5 mm into a roll shape to obtain a roll. Then, the roll was inserted into an aluminum sheathing pipe (material: 1070) having an outer diameter of 70 mm and a thickness of 3 mm, so that the entire outer peripheral surface of the roll was covered by the sheathing pipe. In the state in which the outer peripheral surface of the roll was covered by the sheathing pipe, approximately the entire outer peripheral surface of the roll was in close contact with the inner peripheral surface of the sheathing pipe.

Thereafter, a disk-shaped aluminum lid (material: 1050) having a diameter of 70 mm and a thickness of 3 mm was overlapped on one longitudinal end face of the sheathing pipe so as to close the opening. In this state, the lid was welded and secured to the one end of the sheathing pipe by welding. With this, only the one end opening of the sheathing pipe was closed by the lid.

Next, the roll was heated in the atmosphere at the temperature of 500° C. for 3 hours by oven. With this, the binder contained in the carbon fiber layer of the roll was removed.

Then, the roll in a heated state was loaded in the container of the extrusion device in a state in which the closed one end of the sheathing pipe was arranged at the front of the extrusion direction. The container temperature and the extrusion die were 500° C., respectively. Then, the roll was extruded at an extrusion rate of 1 mm/min. With this, a composite material of the aluminum and the carbon fibers was obtained.

In the composite material, no surface defect such as, e.g., cracks, occurred in the entirety, and the formability was very good. Further, in the composite material, the carbon fiber layer and the aluminum foil were overlapped alternately in the radial direction of the composite material in a laminated manner. Further, the aluminum of the aluminum foil was sufficiently permeated in the carbon fiber layer, and further both the aluminum foils arranged on both sides of the carbon fiber layer were secured sufficiently with each other. Therefore, the composite material had high strength.

The thermal conductivity of the composite material in the extrusion direction (i.e., the longitudinal direction of the composite material) was 300 W/(m·K), and the linear expansion coefficient was 6×10⁻⁶/K. The thermal conductivity of the composite material in a direction perpendicular to the extrusion direction (i.e., the radial direction of the composite material) was 120 W/(m·K), and the linear expansion coefficient was 20×10⁻⁶/K.

### Example 2

In Example 2, a composite material of aluminum and carbon fibers was produced by the following steps.

Carbon fibers having a length of 200 μm and an average fiber diameter of 10 μm (made by Mitsubishi Plastics Co., Ltd.: K223HM), acrylic resin as a binder, propylene glycol ethyl ether acetate as a solvent, dispersant, and surface conditioner were stirred and mixed. Thus, a coating liquid was obtained. The mass of the binder contained in the coating liquid was 20% in the solid content with respect to the mass of the carbon fibers contained in the coating liquid. The viscosity of the coating liquid was 1,500 mPa·s.

The coating liquid was applied on the entire surface of one surface of a long aluminum foil (material: 1N30) having a thickness of 20 μm and a width of 280 mm by a knife coater to form a coating layer on the aluminum foil, and the coating layer was dried in a drying furnace to remove the solvent contained in the coating layer. With this, a coated foil in which a carbon fiber layer was formed on the aluminum foil was obtained. The coating amount of the carbon fibers contained in the coating layer was 20 g/m².

Next, the coated foil was wound on an aluminum winding core (material: 1050) having a diameter of 5 mm into a roll shape to obtain a roll. Then, the roll was inserted into an aluminum sheathing pipe (material: 1070) having an outer diameter of 70 mm and a thickness of 3 mm, so that the entire outer peripheral surface of the roll was covered by the sheathing pipe. In the state in which the outer peripheral surface of the roll was covered by the sheathing pipe, approximately the entire outer peripheral surface of the roll was in close contact with the inner peripheral surface of the sheathing pipe.

Thereafter, a disk-shaped aluminum lid (material: 1050) having a diameter of 70 mm and a thickness of 3 mm was overlapped on one longitudinal end face of the sheathing pipe so as to close the opening. In this state, the lid was welded and secured to the one end of the sheathing pipe by swaging. With this, only the one end opening of the sheathing pipe was closed by the lid.

Next, the roll was heated in the atmosphere at the temperature of 500° C. for 3 hours by oven. With this, the binder contained in the carbon fiber layer of the roll was removed.

Then, the roll in a heated state was loaded in the container of the extrusion device in a state in which the closed one end of the sheathing pipe was arranged at the front of the extrusion direction. The container temperature and the extrusion die were 500° C., respectively. Then, the roll was extruded at an extrusion rate of 1 mm/min. With this, a composite material of the aluminum and the carbon fibers was obtained.

In the composite material, no surface defect such as, e.g., cracks, occurred in the entirety, and the formability was very good. Further, in the composite material, the carbon fiber layer and the aluminum foil were overlapped alternately in the radial direction of the composite material in a laminated manner. Further, the aluminum of the aluminum foil was sufficiently permeated in the carbon fiber layer, and further both the aluminum foils arranged on both sides of the carbon fiber layer were secured sufficiently with each other. Therefore, the composite material had high strength.

The thermal conductivity of the composite material in the extrusion direction (i.e., the longitudinal direction of the composite material) was 250 W/(m·K), and the linear expansion coefficient was 10×10⁻⁶/K. The thermal conductivity of the composite material in a direction perpendicular to the extrusion direction (i.e., the radial direction of the composite material) was 100 W/(m·K), and the linear expansion coefficient was 21×10⁻⁶/K.

### Example 3

In Example 3, in the same manner as in the aforementioned Example 1, a composite material of aluminum and carbon fibers was produced except that the one end opening of the sheathing pipe was not closed in the aforementioned Example 2.

Although cracks occurred only at the leading end portion of the composite material in the extrusion direction, no surface defect such as, e.g., cracks, occurred at the intermediate portion of the composite material in the extrusion direction. Therefore, the formability was somewhat favorable. Further, in the portion of the composite material on the tail side than the intermediate portion in the extrusion direction, the content of the aluminum was slightly larger than the intermediate portion of the composite material in the extrusion direction (in other words, the content of the carbon fibers was slightly fewer than the intermediate portion of the composite material in the extrusion direction).

The physical properties (thermal conductivity, linear expansion coefficient) of the intermediate portion of the composite material in the extrusion direction were approximately the same as the aforementioned Example 2.

### Comparative Example 1

In Comparative Example 1, it was tried to produce a composite material of aluminum and carbon in the same manner as in the aforementioned Example 1 except that carbon powders (made by Showa Denko Co., Ltd.: Shocaraiser (registered trademark)-S) having an average grain diameter of 180 μm was used in place of the carbon fibers in the aforementioned Example 1. As a result, when the roll was extruded, the roll was not solidified and the aluminum foil was extruded. Therefore, the formability was poor. For this reason, the physical properties (thermal conductivity, linear expansion coefficient) of the composite material could not be measured.

### Comparative Example 2

In Comparative Example 2, in the same manner as in the aforementioned Example 1, a composite material of aluminum and carbon fibers was produced except that the coating amount of the carbon fibers contained in the coating layer was 50 g/m².

Cracks partially occurred in the composite material. Cutting the composite material and observing the cut surface revealed that there were small gaps inside the composite material. For this reason, it was attempted to obtain a test piece for measuring the physical properties (thermal conductivity, linear expansion coefficient) from the composite material, it was failed to obtain a test piece suitable for measuring because there existed a number of gaps.

The results of the aforementioned Examples 1 to 3 and Comparative Examples 1 and 2 are shown in Table 1 collectively.

TABLE 1

| | | | | | | | Linear |
|---|---|---|---|---|---|---|---|
| | | | Coating | | | Thermal | expan- |
| | | | amount | | | conduc- | sion |
| | | Binder | of | | | tivity | coeffi- |
| | Shape | ratio | carbon | | | (W/m · | cient |
| | of | (mass | fibers | Pack- | Forma- | K) | (10⁻⁶/K) |
| | carbon | %) | (g/m²) | aging | bility | Extrusion direction | |
| Ex. 1 | Fiber | 3 | 30 | Pipe | ◯ | 300 | 6 |
| | | | | and | | | |
| | | | | lid | | | |
| Ex. 2 | Fiber | 20 | 20 | Pipe | ◯ | 250 | 10 |
| | | | | and | | | |
| | | | | lid | | | |
| Ex. 3 | Fiber | 20 | 20 | Pipe | Δ | 250 | 10 |
| Com. | Powder | 3 | 30 | Pipe | X | — | — |
| Ex. 1 | | | | and | | | |
| | | | | lid | | | |
| Com. | Fiber | 3 | 50 | Pipe | X | — | — |
| Ex. 2 | | | | and | | | |
| | | | | lid | | | |

In the column of “formability” in Table 1, “∘” denotes that the formability was very good, and “A” denotes that the formability was somewhat favorable, and “x” denotes that the formability was poor.

In the column of “packaging” in Table 1, “pipe and lid” denotes that a sheathing pipe was used as a packaging material and one end opening of the sheathing pipe was covered by a lid. Further, “pipe” denotes that a sheathing pipe was used as a packaging material and both end openings of the sheathing pipe were not covered by a lid, respectively.

The present application claims priority to Japanese Patent Application No. 2014-105297 filed on May 21, 2014, the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

### INDUSTRIAL APPLICABILITY

The present invention is applicable to a method of producing a composite material of aluminum and carbon fibers, and a composite material of aluminum and carbon fibers.

### BRIEF DESCRIPTION OF SYMBOLS

1: aluminum foil
2: carbon fiber
3: binder
4: solvent
5: coating liquid
6: coating layer
7: carbon fiber layer
8: coated foil
10: roll
15: packaging material
16: sheathing pipe
17: lid
20: composite material of aluminum and carbon fibers
40: coating device
47: oven
50: extrusion device

1. A method of producing a composite material of aluminum and carbon fibers, comprising:
a coating step of applying a coating liquid containing carbon fibers, a binder, and a solvent for the binder in a mixed state on an aluminum foil to form a coating layer on the aluminum foil;
a solvent removal step of removing the solvent contained in the coating layer to obtain a coated foil in which a carbon fiber layer is formed on the aluminum foil;
a roll formation step of winding the coated foil in a roll shape to obtain a roll;
a binder removal step of removing the binder contained in the carbon fiber layer of the roll; and
an extrusion step of extruding the roll after the binder removal step,
wherein in the coating step, the coating liquid is applied on the aluminum foil so that a coating amount of the carbon fibers contained in the coating layer becomes equal to or less than 40 g/m².

2. The method of producing a composite material of aluminum and carbon fibers as recited in claim 1, wherein a length of the carbon fibers contained in the coating liquid is equal to or less than 1 mm.

3. The method of producing a composite material of aluminum and carbon fibers as recited in claim 1, wherein in the coating step, the coating liquid is applied on the aluminum foil so that a volume of the aluminum foil exceeds 50% with respect to a total volume of a volume of the aluminum foil and a volume of the carbon fibers contained in the coating layer.

4. The method of producing a composite material of aluminum and carbon fibers as recited in claim 1, wherein the coating liquid contains the carbon fibers and the binder so that a mass of the binder becomes 0.5% to 25% with respect to a mass of the carbon fibers.

5. The method of producing a composite material of aluminum and carbon fibers as recited in claim 1, further comprising a covering step of covering an outer peripheral surface of the roll by an aluminum packaging material between the roll formation step and the binder removal step,
wherein in the binder removal step, the binder contained in the carbon fiber layer of the roll is removed after the covering step.

6. The method of producing a composite material of aluminum and carbon fibers as recited in claim 5, wherein in the covering step, the outer peripheral surface of the roll is covered by the packaging material by inserting the roll in an aluminum sheathing pipe as the packaging material.

7. The method of producing a composite material of aluminum and carbon fibers as recited in claim 5, further comprising a closing step of closing at least one of both end openings of the packaging material between the covering step and the binder removal step or between the binder removal step and the extrusion step.

8. The method of producing a composite material of aluminum and carbon fibers as recited in claim 7, wherein in the extrusion step, the roll is extruded in a state in which a closed end of the packaging material is arranged at a front of the extrusion direction.

9. The method of producing a composite material of aluminum and carbon fibers as recited in claim 7, wherein at least one of both end openings of the packaging material is closed by an aluminum lid.

10. The method of producing a composite material of aluminum and carbon fibers as recited in claim 5, further comprising a closing step of closing only one end opening of the packaging material by an aluminum lid between the covering step and the binder removal step,
wherein in the extrusion step, the roll is extruded in a state in which a closed end of the packaging material is arranged on a front of the extrusion direction.

11. The method of producing a composite material of aluminum and carbon fibers as recited in claim 5, wherein in the binder removal step, the roll is heated in the atmosphere at a temperature of 350 to 600° C. for one hour or more to remove the binder.

12. A composite material of aluminum and carbon fibers obtained by the method of producing a composite material of aluminum and carbon fibers as recited in claim 1.
